(19) United States
(12) Patent Application Publication
(10) Pub. No.: US 2026/0320737 A1
(43) Pub. Date: Oct. 15, 2026

(54) METHOD AND SYSTEM FOR DEMOSAICING OF IMAGES CAPTURED USING DIFFERENT TYPES OF COLOR FILTER ARRAYS

(71) Applicant: Samsung Electronics Co., Ltd., Suwon-si, Gyeonggi-do (KR)

(72) Inventors: Saurabh KUMAR, Bangalore (IN); Nutan Sairam YENNETI, Bangalore (IN); Rahul VARNA, Bangalore (IN)

(21) Appl. No.: 19/684,380

(22) Filed: May 21, 2026

Related U.S. Application Data
(63) Continuation of application No. PCT/KR2026/000373, filed on Jan. 7, 2026.

(30) Foreign Application Priority Data
Jan. 8, 2025 (IN) 202541001901
Dec. 11, 2025 (IN) 2025 41001901

(51) Int. Cl. G06T 3/4015; H04N 23/84; H04N 25/13

(52) U.S. Cl. CPC G06T 3/4015; H04N 23/843; H04N 25/134

(57) ABSTRACT

A method for demosaicing of images captured using different types of color filter arrays (CFA)in a device are provided. The method includes receiving an input CFA data comprising one or more CFA images from one or more CFAs, determining a CFA type associated with each CFA image of the one or more CFA images using a CFA identification module, identifying, for each CFA image, a CFA-specific encoder from an encoder pool based on the determined CFA type, encoding each CFA image using the identified CFA-specific encoder to generate a latent embedding corresponding to each CFA image, processing the latent embedding of each CFA image using the common central core to generate core latent embeddings, and generating a linear red, green, blue (RGB) image by decoding the core latent embeddings using a decoder.

### CROSS-REFERENCE TO RELATED APPLICATION(S)

This application is a continuation application, claiming priority under 35 U.S.C. § 365(c), of an International application No. PCT/KR2026/000373, filed on Jan. 7, 2026, which is based on and claims the benefit of an Indian Provisional patent application number 202541001901, filed on Jan. 8, 2025, in the Indian Intellectual Property Office, and of an Indian Complete patent application number 202541001901, filed on Dec. 11, 2025, in the Indian Intellectual Property Office, the disclosure of each of which is incorporated by reference herein in its entirety.

### FIELD OF THE INVENTION

The disclosure relates to photography. More particularly, the disclosure relates to a unified system and method for demosaicing raw images captured from multiple types of color filter arrays (CFAs) in image sensors, specifically in mobile devices such as smartphones.

### BACKGROUND

Demosaicing is a crucial process in image processing that involves converting raw data captured by camera image sensors with color filter arrays (CFAs) into full-color images. The most commonly used CFA formats include Bayer, Tetra, Nona, and HexaDeca, each having a distinct arrangement of color filters. Traditional demosaicing methods typically rely on interpolation techniques to estimate missing pixel values, which can either be iterative or non-iterative in nature. While these methods are applicable to different CFA formats, the quality of the resulting image tends to degrade as the color grid size of the CFA increases. As a result, there is a loss in the accuracy of the color reproduction when using traditional techniques across different CFA types.

In recent years, deep learning-based methods have emerged as a more effective solution for demosaicing tasks. These methods leverage neural networks to learn a mapping between CFA raw captures and their corresponding full-color images. Deep learning models can process the image data quickly and are highly parallelizable, making them suitable for real-time applications. However, a significant limitation of current deep learning approaches is that they are typically trained to handle only one specific CFA format. Consequently, models that are trained on one CFA type, such as Bayer, fail to generalize to other CFA formats like Tetra, Nona, or HexaDeca. This specificity restricts their applicability and reduces their flexibility in handling various CFA formats.

The existing unified demosaicing model for various CFA patterns with neural network architecture consists of a very small number filters of especially fine-tuned to each CFA type while also being active for other CFA types. Therefore, the existing technique leads to an output with an inferior image quality of final red, green, blue (RGB) output image.

Additionally, using a separate model for each CFA requires storing, loading each of the individual models, which takes system resources apart from the training, development and maintenance cycles that need to be performed for each of them leading to a larger research and development resource.

The above information is presented as background information only to assist with an understanding of the disclosure. No determination has been made, and no assertion is made, as to whether any of the above might be applicable as prior art with regard to the disclosure.

### SUMMARY

Embodiments of the disclosure are to address at least the above-mentioned problems and/or disadvantages and to provide at least the advantages described below. Accordingly, an aspect of the disclosure is to provide a system and method for demosaicing raw images captured from multiple types of Color Filter Arrays (CFAs) in image sensors, specifically in mobile devices such as smartphones.

Additional aspects will be set forth in part in the description which follows and, in part, will be apparent from the description, or may be learned by practice of the presented embodiments.

In accordance with an aspect of the disclosure, a method for unified demosaicing of images captured using different types of color filter arrays (CFAs) in a device is provided. The method includes receiving an input CFA data comprising one or more CFA images from one or more CFAs and determines a CFA type associated with each CFA image of the one or more CFA images using a CFA identification module. The method includes identifying for each CFA image, a CFA-specific encoder from an encoder pool based on the determined CFA type and encodes each CFA image using the identified CFA-specific encoder to generate a latent embedding corresponding to each CFA. The method further includes processing the latent embedding of each CFA image using a central core to generate core latent embeddings and generates a linear RGB image by decoding the core latent embeddings using a decoder.

In accordance with another aspect of the disclosure, an apparatus for demosaicing of images captured using different types of color filter arrays (CFAs) in a device is provided. The apparatus includes memory configured to store at least one instruction. The apparatus may include at least one processing unit, wherein, when executed by the at least one instruction, the at least one processing unit to control the apparatus is configured to receive an input CFA data comprising one or more CFA images from one or more CFAs, determine a CFA type associated with each CFA image of the one or more CFA images using a CFA identification module, identify, for each CFA image, a CFA-specific encoder from an encoder pool based on the determined CFA type, encode each CFA image using the identified CFA-specific encoder to generate a latent embedding corresponding to each CFA image, process the latent embedding of each CFA image using a central core to generate core latent embeddings, and generate a linear red, green, blue (RGB) image by decoding the core latent embeddings using a decoder.

In an embodiment of the disclosure, one or more non-transitory computer-readable storage media storing one or more computer programs including computer-executable instructions that, when executed by one or more processors of an electronic device individually or collectively, cause the electronic device to perform operations are provided. The operations include receiving an input CFA data comprising one or more CFA images from one or more CFAs, determining a CFA type associated with each CFA image of the one or more CFA images using a CFA identification module, identifying, for each CFA image, a CFA-specific encoder from an encoder pool based on the determined CFA type, encoding each CFA image using the identified CFA-specific encoder to generate a latent embedding corresponding to each CFA image, processing the latent embedding of each CFA image using a central core to generate core latent embeddings, and generating a linear red, green, blue (RGB) image by decoding the core latent embeddings using a decoder.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS:

The aspects, features, and advantages of embodiments of the disclosure will be more apparent from the following description taken in conjunction with the accompanying drawings, in which:

FIG. 1 illustrates a block diagram of a system for unified demosaicing raw images, according to an embodiment of the disclosure;

FIG. 2 depicts a flow graph illustrating the processing and functionality of a system, according to an embodiment of the disclosure;

FIG. 3 is a block diagram illustrating the latent-domain multi-frame fusion mechanism, according to an embodiment of the disclosure;

FIG. 4 is a block diagram illustrating the single-frame processing pipeline of the unified CFA demosaicing system, according to an embodiment of the disclosure;

FIG. 5 is a block diagram illustrating the architecture and internal operation of the color filter array (CFA) identification module, according to an embodiment of the disclosure; and

FIG. 6 is a flow diagram of a method for unified demosaicing of images captured using different types of color filter arrays (CFAs) in a device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, the word “exemplary” is used herein to mean “serving as an example, instance, or illustration.” Any embodiment or implementation of the disclosure matter described herein as “exemplary” is not necessarily to be construed as preferred or advantageous over other embodiments.

The terms “comprises,” “comprising,” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

A significant challenge exists in developing a unified deep learning model capable of handling multiple CFA formats, such as Bayer, Tetra, Nona, and HexaDeca, simultaneously. There is need for a method and system to overcome the limitations of current deep learning approaches, which are confined to single CFA formats, and provide a more generalized and robust solution for diverse and multi-frame imaging applications.

The disclosure addresses the aforementioned problems by providing a unified method and system for demosaicing and image processing of single and multiple CFA image frames. The disclosure discloses a method and a system capable of demosaicing multiple CFA patterns. This reduces required storage space by avoiding the need to have multiple deep models for each camera, while providing comparable and/or higher image quality than standalone models. Initially, raw data associated with the color filter array (CFA) of an image sensor of a camera is received. The disclosure via the CFA-identification module identifies the CFA format. A person skilled in the art may appreciate that the CFA format may be at least one of a Bayer CFA format, a Nona CFA format, a tetra CFA format and a HexaDeca CFA format. Further, an encoder is identified based on the provided CFA format and encoding the raw data associated with the CFA format. The encoded raw data is processed by the common central core for single or multi-frame imaging tasks in core feature domain and the processed raw data is decoded using the decoder to reconstruct full-color image generated from the raw data associated with CFA format.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

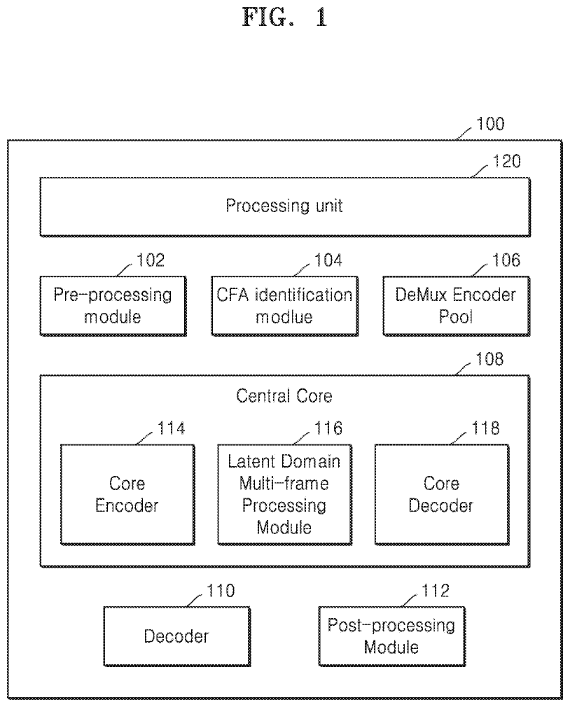

FIG. 1 illustrates a block diagram of a system for unified demosaicing raw images captured using various color filter arrays (CFAs), such as Bayer, Tetra, Nona, and Hexadeca patterns, in both single-frame and multi-frame scenarios, according to an embodiment of the disclosure.

Referring to FIG. 1, the system 100 may comprise a pre-processing module 102, a CFA identification module 104, a DeMux encoder pool 106, a central core 108, a decoder 110, and a post-processing module 112, but not limited thereto. The central core 108 comprises a core encoder 114, a latent domain multi-frame processing module 116, and a core decoder 118. In an embodiment, the latent domain multi-frame processing 116 comprises a Saturation Map Generator, a Motion Map Generator, a blending and fusion module, but not limited thereto. All these modules may be integral parts of a processing unit 120 or the processing unit 120 may control the operation of the one or more modules. In an embodiment, the modules may be a software module, a hardware module, or a combination thereof.

The system begins by receiving one or more raw CFA images. The CFA identification module 104 may determine the CFA type for each input using frequency-domain transformation and comparison with onboard reference frequency signatures. Based on the identified CFA type, a corresponding encoder from the shared encoder pool 106 may be selected. Each encoder may convert the pre-processed raw image into a latent embedding that is then processed by the central core 108. For single-frame input, the central core 108 may extracts and refines the latent features. For multi-frame inputs, the central core 108 may generate a saturation map and a motion map to guide the fusion of core features from multiple frames. These blended features may be decoded into a linear RGB image which undergoes post-processing steps including tone mapping and enhancement to produce the final output. The system supports use cases including single-frame CFA demosaicing, multi-frame HDR blending with the same CFA, and fusion of images captured using different CFAs or resolutions. The unified model reduces ROM usage, simplifies development and maintenance, and ensures consistent output quality. It is also scalable, allowing for future CFA types to be integrated by updating the encoder pool and reference signatures.

According to an embodiment, one or more modules may be implemented by the processor 120 executing one or more software code, programs or instructions stored in memory or a storage.

The processor 120 may write data to a memory or read data stored in the memory. In particular, the processor 120 may process data according to defined operation rules or an artificial intelligence (AI) model by executing a program or at least one instruction stored in the memory. Accordingly, the processor 120 may perform operations described in the following embodiments, and unless otherwise specified, operations described as being performed by the system 100 or by components included in the system 100 may be understood as being performed by the processor 120.

The memory may be a component configured to store various programs or data, and may include a storage medium such as a read-only memory (ROM), random access memory (RAM), hard disk, CD-ROM, DVD, or a combination of such storage media. The memory may not be implemented as a separate component but may be integrated into the processor 120. The memory may include volatile memory, non-volatile memory, or a combination of volatile and non-volatile memory. A program or at least one instruction for performing operations according to the embodiments described below may be stored in the memory. The memory may also provide the stored data to the processor 120 in response to a request from the processor 120.

The detailed functionality of the system 100 is explained in foregoing paragraphs in conjunction with subsequent figures.

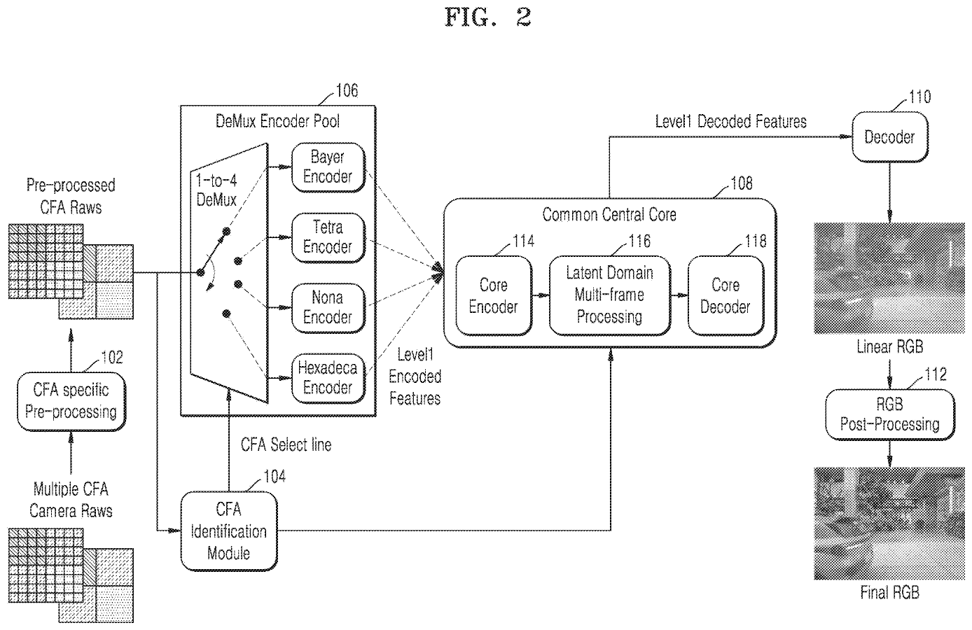

FIG. 2 depicts a flow graph illustrating the processing and functionality of a system, according to an embodiment of the disclosure.

Referring to FIG. 2, the process may begin with the receiving of raw image data (CFA data) captured using one or more types of Color Filter Arrays (CFAs). The CFA format may be Bayer CFA format, a Nona CFA format, a tetra CFA format and a HexaDeca CFA format, but not limited thereto. The raw data may be subjected to CFA-specific pre-processing, which includes operations such as black level correction, lens shading correction, auto white balance, and bad pixel correction, but not limited thereto. Once pre-processed, each CFA image may be processed by the CFA identification module that determines its CFA type. The identification may be performed based on a frequency-domain transform, such as a Fourier transform, that converts the image into the frequency domain. For identification, the horizontal and vertical mid-slices of the frequency domain may be extracted and averaged to obtain a unique frequency signature, which is compared against stored reference signatures to classify the CFA type. The CFA type may be determined by correlating the extracted frequency signature with reference frequency signatures corresponding to known CFA types.

The Demux encoder pool 106 may include a 1-to-4 Demux, hereinafter referred to as ‘Demux’, and an encoder pool. The encoder pool may include a Bayer encoder, a Tetra encoder, a Nona encoder, and a Hexadeca encoder. The CFA identification module 104 may provide control signals to control the DeMux. Based on these control signals, the DeMux may identify or select an encoder among the encoder pool. Each CFA type, such as Bayer, Tetra, Nona, and Hexadeca, has a dedicated encoder within this pool. Once identified, the encoder may process the input image and produces latent embedding i.e., Level 1 encoded features in a unified latent space representation. These features may be provided as input to the central core 108 for processing. Level 1 Encoded Features may be designed to bring the encodings of various CFA types to the same latent dimension for subsequent processing by central core 108.

In the single-frame scenario, the central core 108 may include the core encoder 114 that extracts core latent embeddings i.e., deeper core features and a corresponding core decoder 118 to decode the core latent embeddings. The decoded core latent embeddings may be Level 1 decoded features. The decoded core latent embeddings may be provided to the decoder 110 of the system to reconstruct a linear RGB image.

Whereas, in multi-frame processing scenarios, the central core 108 may further include a latent domain multi-frame processing module 116. The central core 108 may accept encoded features from multiple frames and generates a saturation map to identify under-exposed or over-exposed regions and a motion map to detect local and global motion between frames, using the latent-domain multi-frame fusion 116. Using these maps as blending weights, the system may fuse the core features in the latent space, which results in a set of blended core features. These features may be decoded into Level 1 decoded features by the core-decoder 118 and subsequently into a linear RGB image by the final Decoder 110.

The decoder 110 may decode the Level 1 decoded features from the central core 108 into a reconstructed linear RGB image for further post processing 112. The decoder 110 is a decoder neural networks to convert the feature representation in a 3-channel RGB image.

The linear RGB output may be post-processed 112 through a standard image enhancement pipeline that performs color correction, tone mapping, and sharpening to produce a final enhanced RGB image suitable for display or storage. The system supports three primary use cases. In single frame demosaicing, raw input from any CFA type may be processed individually through the unified model. In same-CFA multi-frame fusion (e.g., for HDR or noise reduction), multiple exposures may be blended using motion and saturation maps. In multi-CFA or multi-resolution fusion, the raw images captured using different CFA patterns may be processed and fused within the same latent domain, leveraging the unified structure of the model.

The functionality of the system 100 may be extended for incorporating new CFA types by extending the Demux encoder pool 106 to add the new CFA types and the corresponding CFA specific encoders.

In this manner, the disclosed system provides several technical advantages. The system eliminates the need to store multiple ISP models, which reduces overall memory footprint. The system also ensures consistent quality across various sensor types and CFA configurations, streamlining post-processing. The system also simplifies development and scalability, as additional CFA types can be integrated by training new encoders and updating the frequency signature database. The architecture is compatible with AI-based processing and can be accelerated using neural processing units (NPUs) or GPUs, making it practical for real-time deployment in consumer devices.

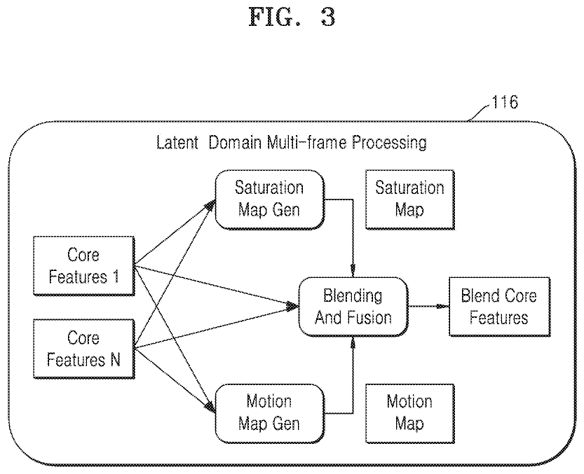

FIG. 3 is a block diagram illustrating the latent-domain multi-frame fusion mechanism described in FIG. 2 according to an embodiment of the disclosure. FIG. 3 illustrates motion-aware blending on image reconstruction.

Referring to FIG. 3, two blocks labeled as Core Features 1 and Core Features N represent the latent core features extracted from two different raw input frames, which may be captured either from the same CFA type or different CFAs. These frames represent different temporal instances of the same scene, where object motion may have occurred between the captures. The extraction of core features may be performed as described previously, via CFA-specific encoders followed by a shared core encoder 114 that transforms Level 1 features into deeper latent representations suitable for fusion. Further, the core features may be are processed by the saturation map generator to generate the saturation map and by the motion map generator which generates the motion map.

The saturation map generator may analyze the exposure levels in the latent features and generates a map that identifies under-exposed and over-exposed regions across the frames. This enables the fusion mechanism to preferentially weight well-exposed regions during blending.

The saturation map generator may estimate the saturation map between the N core-domain features of the N level 1 features where one of them is used as reference and the others have the same or different scene exposures. The saturation map generator may be a U-Net-based network architecture that takes in N core features and produce a saturation map for use in fusion.

Specifically, the motion map generator may compute pixel-wise motion between the core feature sets using the U-Net-based network architecture. This map may encode local and global motion, facilitating motion-compensated blending to avoid ghosting and alignment issues during reconstruction.

Both the saturation map and the motion map may be fed into the blending and fusion module, which performs fusion of the N input core features using the two maps as spatial weights. Particularly, the fusion may be performed using weights that are convex combinations. The blending fusion may produce a single, blended core feature representation, which aggregates the most reliable, motion-aligned, and well-exposed regions from each frame within the latent domain.

The blended core features may be then passed into the core 118, which inverts the transformation applied by the core encoder 114. The core decoder 118 may reconstruct Level 1 decoded features, which serve as an intermediate representation bridging the latent space and pixel space. These features may be further processed by a downstream decoder (not shown in this figure) to reconstruct a full-resolution linear RGB image, which is then tone-mapped and enhanced into a display-ready final output.

In an embodiment, the motion map may be used by the blending and fusion module to perform motion-compensated fusion, where regions in one core feature set may be spatially aligned and weighted relative to their counterparts in the other frame before blending. Such motion-aware blending significantly improves clarity, especially in dynamic regions such as the moving vehicle. The surrounding background may also remain undistorted, which suggests that the fusion successfully preserves static and dynamic elements in a consistent and coherent manner.

In this manner, by incorporating motion-awareness directly in the latent space, the system effectively mitigates artifacts associated with dynamic scenes, which enables robust and high-quality reconstruction in real-world multi-frame imaging scenarios.

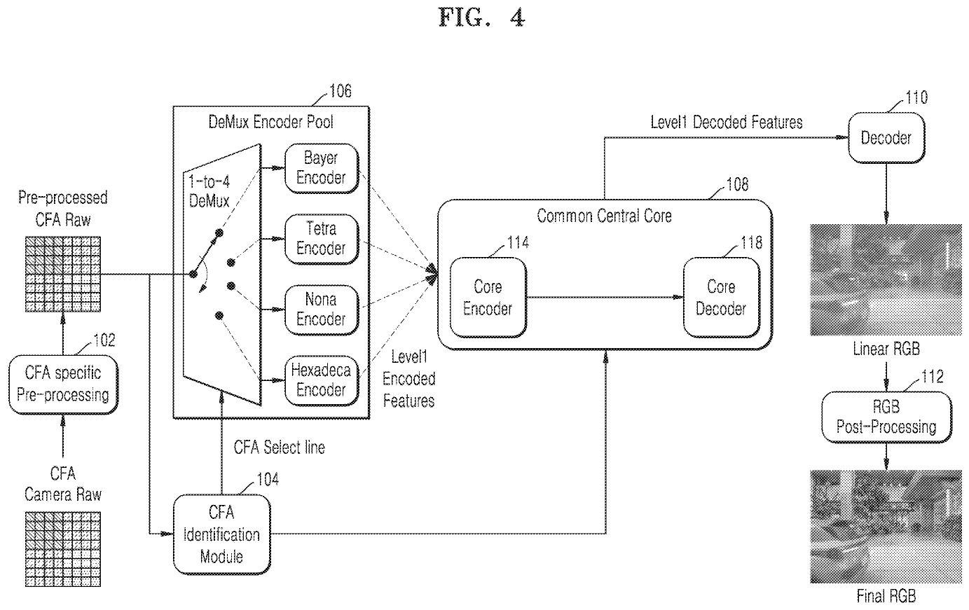

FIG. 4 is a block diagram illustrating the single-frame processing pipeline of the unified CFA demosaicing system according to an embodiment of the disclosure.

Referring to FIG. 4, unlike the multi-frame processing architecture (shown in FIGS. 2 and 3), which includes latent-domain fusion using saturation and motion maps, the pipeline in FIG. 4 is designed to handle a single input image frame captured using any supported Color Filter Array (CFA), such as Bayer, Tetra, Nona, or Hexadeca. The process begins with a raw image captured from an imaging sensor, which is subjected to CFA-specific pre-processing 102. This stage may include essential image normalization tasks such as black level subtraction, lens shading correction, white balance adjustment, and bad pixel correction, ensuring that the data is in a consistent form for further processing regardless of the CFA type. The pre-processed raw image may be then passed to a CFA identification module 104, which applies a frequency-domain analysis (such as a Fourier transform) to determine the CFA type of the input. This identification may be achieved by extracting mid-slice frequency signatures from the transformed data and matching them against known CFA signature templates. The CFA identification module 104 may output a CFA type label, which is used to direct the image to the appropriate encoder.

Based on the CFA type, a 1-to-n DeMux may route the pre-processed raw image to the corresponding CFA-specific encoder, i.e., one of Bayer, Tetra, Nona, or Hexadeca encoders. Each encoder may be a lightweight neural network designed to project the input image into a unified latent feature space, producing a representation referred to as Level 1 Encoded Features. The encoded features may be passed into the core encoder, which may be a deep neural network module within the central core of the system. The core encoder 114 may extract higher-level semantic features, generating a latent representation called core features. Unlike the multi-frame case, where several such feature maps are fused, here only a single set of core features may be processed. These core features are then passed to a core decoder 118, which performs an inverse transformation, reconstructing Level 1 decoded features. These features retain the demosaiced color information and structural integrity of the original frame, encoded in a format ready for final decoding.

The Level 1 decoded features may be processed by the decoder 110, which reconstructs a full-resolution linear RGB image. This image may represent the raw color output from the demosaicing network, prior to post-processing. Finally, the linear RGB image may be passed through an RGB post-processing module 112, which performs tone mapping, color correction, contrast enhancement, and sharpening to generate the final high-quality enhanced RGB Image suitable for display or storage.

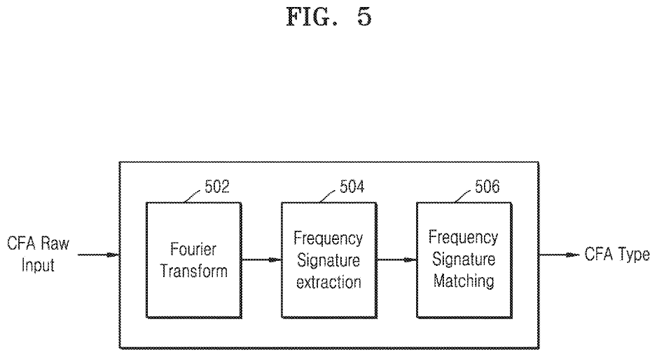

FIG. 5 is a block diagram illustrating the architecture and internal operation of the color filter array (CFA) identification module according to an embodiment of the disclosure.

Referring to FIG. 5, the module 104 may be responsible for automatically determining the CFA type (e.g., Bayer, Tetra, Nona, Hexadeca) associated with an incoming raw image, which enables downstream selection of the appropriate CFA-specific encoder. The CFA identification module may comprise three key sub-blocks: Fourier transform block 502, frequency signature extraction block 504, and frequency signature matching block 506. The process may begin with a CFA raw input, which is a pre-processed raw image captured from a sensor using an unknown CFA type. This raw image may be first passed to the Fourier Transform block 502, where it undergoes transformation into the frequency domain. The use of the Fourier domain may help to highlight periodic patterns that are characteristic of different CFA types.

The frequency-domain representation may be then passed to the frequency signature extraction block 504. Here, horizontal and vertical mid-slices of the frequency spectrum may be extracted and averaged to compute a compact frequency signature. This signature may be designed to capture the spatial periodicity and frequency characteristics that uniquely identify the structure of the CFA pattern used to capture the input. Next, the computed frequency signature may be passed into the frequency signature matching block 506. This frequency signature matching block 506 component may compare the extracted signature with a library of pre-stored reference signatures corresponding to known CFA types. The comparison may be based on correlation, distance metrics, or learned similarity scoring techniques. Upon identifying the closest matching reference signature, the frequency signature matching block 506 component may output a CFA Type label, such as “00” for Bayer, “01” for Tetra, “10” for Nona, or “11” for Hexadeca. The CFA type may be then used by subsequent components of the pipeline, specifically the 1-to-4 DeMux encoder pool, to route the raw image to the appropriate CFA-specific encoder. This automatic identification may enable the system to remain CFA-agnostic at runtime and eliminates the need for hardcoded CFA selection logic.

The CFA identification module 104 may be extended by adding frequency signatures of new CFA types for incorporating them in the unified model.

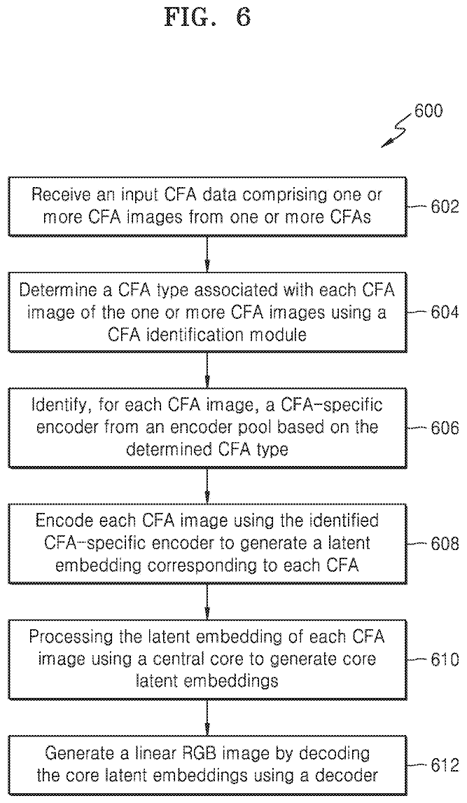

FIG. 6 is a flow diagram of a method for demosaicing of images captured using different types of color filter arrays (CFAs) in a device, according to an embodiment of the disclosure.

Referring to FIG. 6, at operation 602, the method 600 may comprise receiving an input CFA data comprising one or more CFA images from one or more CFAs. The CFA format may be at least one of a Bayer CFA format, a Nona CFA format, a tetra CFA format and a HexaDeca CFA format. However, it should be understood that the CFA format(s) described herein are intended as exemplary, and other formats may be incorporated within the scope of the disclosure.

At operation 604, the method 600 may recite determining a CFA type associated with each CFA image of the one or more CFA images using a CFA identification module 104. The determination of the CFA type may comprise applying a frequency-domain transform to each CFA image to extract a frequency signature and using the extracted frequency signature to determine the CFA type. The CFA type may be determined by correlating the extracted frequency signature with reference frequency signatures corresponding to known CFA types. The applying of the frequency-domain transform to each CFA image to extract the frequency signature may comprise converting the CFA image into frequency domain, extracting horizontal and vertical mid-slices of the frequency domain data, and averaging the mid-slices to obtain the frequency signature.

At operation 606, the method 600 may recite identifying, for each CFA image, a CFA-specific encoder from an encoder pool based on the determined CFA type.

At operation 608, the method 600 may recite encoding each CFA image using the identified CFA-specific encoder to generate a latent embedding corresponding to each CFA image. The latent embedding may be Level 1 encoded features corresponding to each CFA image. When the input CFA data comprise a single CFA image, the processing of the latent embedding using the central core to generate core latent embeddings may further comprise processing the latent embeddings using a core encoder to extract core features for generation of the core latent embeddings. The core latent embeddings may be Level 1 decoded features corresponding.

At operation 610, the method 600 may recite processing the latent embedding of each CFA image using a central core to generate core latent embeddings. When the input CFA data comprise a plurality of CFA images, the processing of the latent embedding using the central core to generate the core latent embeddings may comprise processing the latent embedding corresponding to each CFA image to extract core features corresponding to each CFA image., The processing the latent embedding may further comprise generating a saturation map and a motion map between the core features of the plurality of CFA images. The processing the latent embedding may further comprise, and blending the core features of the plurality of CFA images based on the saturation map and the motion map to generate the blended core latent embedding. The saturation map and the motion map may provide weights to the core features of the plurality of CFA images, and the blending of the core features may be performed based on the corresponding weights.

At operation 612, the method 600 may recite generating a linear RGB image by decoding the core latent embeddings using a decoder. The method may further comprise generating an enhanced RGB image by performing post-processing on the generated linear RGB image.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

It may be noted here that the subject matter of some or all embodiments described with reference to FIGS. 1 to 3 may be relevant for the methods and the same is not repeated for the sake of brevity.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, nonvolatile memory, hard drives, compact disc (CD) ROMs, digital video disc (DVDs), flash drives, disks, and any other known physical storage media.

Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a,” “an” and “the” mean “one or more,” unless expressly specified otherwise. The terms “including,” “comprising,” “having” and variations thereof, when used in a claim, is used in a non-exclusive sense that is not intended to exclude the presence of other elements or steps in a claimed structure or method, unless expressly specified otherwise.

While the disclosure has been shown and described with reference to various embodiments thereof, it will be understood by those skilled in the art that various changes in form and details may be made therein without departing from the spirit and scope of the disclosure as defined by the appended claims and their equivalents.

In an embodiment of the disclosure, a method for demosaicing of images captured using different types of color filter arrays (CFAs) in a device may include receiving an input CFA data comprising one or more CFA images from one or more CFAs. The method may include determining a CFA type associated with each CFA image of the one or more CFA images using a CFA identification module. The method may include identifying, for each CFA image, a CFA-specific encoder from an encoder pool based on the determined CFA type. The method may include encoding each CFA image using the identified CFA-specific encoder to generate a latent embedding corresponding to each CFA image. The method may include processing the latent embedding of each CFA image using a central core to generate core latent embeddings. The method may include generating a linear red, green, blue (RGB) image by decoding the core latent embeddings using a decoder.

In an embodiment of the disclosure, the determining of the CFA type may comprise applying a frequency-domain transform to each CFA image to extract a frequency signature. The determining of the CFA type may include using the extracted frequency signature to determine the CFA type.

In an embodiment of the disclosure, the CFA type may be determined by correlating the extracted frequency signature with reference frequency signatures corresponding to known CFA types.

In an embodiment of the disclosure, the applying of the frequency-domain transform to each CFA image to extract the frequency signature may include converting the CFA image into frequency domain data. The applying of the frequency-domain transform to each CFA image may include extracting horizontal and vertical mid-slices of the frequency domain data. The applying of the frequency-domain transform to each CFA image may include averaging the horizontal and vertical mid-slices to obtain the frequency signature.

In an embodiment of the disclosure, when the input CFA data comprise a single CFA image, the processing of the latent embedding using the central core to generate core latent embeddings may further include processing the latent embeddings using a core encoder to extract core features for generation of the core latent embeddings.

In an embodiment of the disclosure, when the input CFA data comprise a plurality of CFA images, the processing of the latent embedding using the central core to generate the core latent embeddings may include processing the latent embedding corresponding to each CFA image among the plurality of CFA images to extract core features corresponding to each CFA image. The processing of the latent embedding may include generating a saturation map and a motion map between the core features of the plurality of CFA images. The processing of the latent embedding may include blending the core features of the plurality of CFA images based on the saturation map and the motion map to generate the blended core latent embedding.

In an embodiment of the disclosure, the saturation map and the motion map may provide weights to the core features of the plurality of CFA images. In an embodiment of the disclosure, the blending of the core features may be performed based on the corresponding weights.

In an embodiment of the disclosure, the saturation map may identify under-exposed and over-exposed regions across frames based on exposure levels in features of the latent embedding.

In an embodiment of the disclosure, the weights provided to the core features may favor regions that are not under-exposed or over-exposed.

In an embodiment of the disclosure, an apparatus for demosaicing of images captured using different types of color filter arrays (CFAs) in a device, the apparatus may include memory configured to store at least one instruction. The apparatus may include at least one processing unit, wherein, when executed by the at least one instruction, the at least one processing unit is configured to control the apparatus to receive an input CFA data comprising one or more CFA images from one or more CFAs. The at least one processing unit may be configured to determine a CFA type associated with each CFA image of the one or more CFA images using a CFA identification module. The at least one processing unit may be configured to identify, for each CFA image, a CFA-specific encoder from a demux encoder pool based on the determined CFA type. The at least one processing unit may be configured to encode each CFA image using the identified CFA-specific encoder to generate a latent embedding corresponding to each CFA image. The at least one processing unit may be configured to process the latent embedding of each CFA image using a central core to generate core latent embeddings. The at least one processing unit may be configured to generate a linear red, green, blue (RGB) image by decoding the core latent embeddings using a decoder.

In an embodiment of the disclosure, to determine the CFA type, the at least one processing unit may be configured to apply a frequency-domain transform to each CFA image to extract a frequency signature. The at least one processing unit may be configured to use the extracted frequency signature to determine the CFA type.

In an embodiment of the disclosure, the CFA type is determined by correlating the extracted frequency signature with reference frequency signatures corresponding to known CFA types.

In an embodiment of the disclosure, to apply the frequency-domain transform to each CFA image to extract the frequency signature, the at least one processing unit may be configured to convert the CFA image into frequency domain data. The at least one processing unit may be configured to extract horizontal and vertical mid-slices of the frequency domain data. The at least one processing unit may be configured to average the horizontal and vertical mid-slices to obtain the frequency signature.

In an embodiment of the disclosure, when the input CFA data comprise a single CFA image, to process the latent embedding using the central core to generate core latent embeddings, the at least one processing unit may be further configured to process the latent embeddings using a core encoder to extract core features for generation of the core latent embeddings.

In an embodiment of the disclosure, when the input CFA data comprise a plurality of CFA images, to process the latent embedding using the central core to generate the core latent embeddings, the at least one processing unit may be configured to process the latent embedding corresponding to each CFA image among the plurality of CFA images to extract core features corresponding to each CFA image. The at least one processing unit may be further configured to generate a saturation map and a motion map between the core features of the plurality of CFA images. The at least one processing unit may be further configured to blend the core features of the plurality of CFA images based on the saturation map and the motion map to generate the blended core latent embedding.

In an embodiment of the disclosure, the saturation map and the motion map may provide weights to the core features of the plurality of CFA images. The blending of the core features may be performed based on the corresponding weights.

In an embodiment of the disclosure, the saturation map may identify under-exposed and over-exposed regions across frames based on exposure levels in features of the latent embedding.

In an embodiment of the disclosure, the weights provided to the core features may favor regions that are not under-exposed or over-exposed.

In an embodiment of the disclosure, a computer-readable storage media storing one or more computer programs including computer-executable instructions that, when executed by one or more processors of an electronic device individually or collectively, cause the electronic device to perform a method, wherein the method includes receiving an input CFA data comprising one or more CFA images from one or more CFAs. The method may include determining a CFA type associated with each CFA image of the one or more CFA images using a CFA identification module. The method may include identifying, for each CFA image, a CFA-specific encoder from an encoder pool based on the determined CFA type. The method may include encoding each CFA image using the identified CFA-specific encoder to generate a latent embedding corresponding to each CFA image. The method may include processing the latent embedding of each CFA image using a central core to generate core latent embeddings. The method may include generating a linear red, green, blue (RGB) image by decoding the core latent embeddings using a decoder.

What is claimed is:

1. A method for demosaicing of images captured using different types of color filter arrays (CFAs) in a device, the method comprising:
receiving an input CFA data comprising one or more CFA images from one or more CFAs;
determining a CFA type associated with each CFA image of the one or more CFA images using a CFA identification module;
identifying, for each CFA image, a CFA-specific encoder from an encoder pool based on the determined CFA type;
encoding each CFA image using the identified CFA-specific encoder to generate a latent embedding corresponding to each CFA image;
processing the latent embedding of each CFA image using a central core to generate core latent embeddings; and
generating a linear red, green, blue (RGB) image by decoding the core latent embeddings using a decoder.

2. The method of claim 1, wherein the determining of the CFA type comprises:
applying a frequency-domain transform to each CFA image to extract a frequency signature; and
using the extracted frequency signature to determine the CFA type.

3. The method of claim 2, wherein the CFA type is determined by correlating the extracted frequency signature with reference frequency signatures corresponding to known CFA types.

4. The method of claim 2, wherein the applying of the frequency-domain transform to each CFA image to extract the frequency signature comprises:
converting the CFA image into frequency domain data;
extracting horizontal and vertical mid-slices of the frequency domain data; and
averaging the horizontal and vertical mid-slices to obtain the frequency signature.

5. The method of claim 1, wherein when the input CFA data comprise a single CFA image, the processing of the latent embedding using the central core to generate core latent embeddings further comprises:
processing the latent embeddings using a core encoder to extract core features for generation of the core latent embeddings.

6. The method of claim 1, wherein when the input CFA data comprise a plurality of CFA images, the processing of the latent embedding using the central core to generate the core latent embeddings comprises:
processing the latent embedding corresponding to each CFA image among the plurality of CFA images to extract core features corresponding to each CFA image;
generating a saturation map and a motion map between the core features of the plurality of CFA images; and
blending the core features of the plurality of CFA images based on the saturation map and the motion map to generate the blended core latent embedding.

7. The method of claim 6,
wherein the saturation map and the motion map provide weights to the core features of the plurality of CFA images, and
wherein the blending of the core features is performed based on the corresponding weights.

8. The method of claim 7, wherein the saturation map identifies under-exposed and over-exposed regions across frames based on exposure levels in features of the latent embedding.

9. The method of claim 8, wherein the weights provided to the core features favor regions that are not under-exposed or over-exposed.

10. An apparatus for demosaicing of images captured using different types of color filter arrays (CFAs) in a device, the apparatus comprising:
memory configured to store at least one instruction; and
at least one processing unit,
wherein, when executed by the at least one instruction, the at least one processing unit is configured to:
receive an input CFA data comprising one or more CFA images from one or more CFAs,
determine a CFA type associated with each CFA image of the one or more CFA images using a CFA identification module,
identify, for each CFA image, a CFA-specific encoder from an encoder pool based on the determined CFA type,
encode each CFA image using the identified CFA-specific encoder to generate a latent embedding corresponding to each CFA image,
process the latent embedding of each CFA image using a central core to generate core latent embeddings, and
generate a linear red, green, blue (RGB) image by decoding the core latent embeddings using a decoder.

11. The apparatus of claim 10, wherein to determine the CFA type, the at least one processing unit is configured to:
apply a frequency-domain transform to each CFA image to extract a frequency signature; and
use the extracted frequency signature to determine the CFA type.

12. The apparatus of claim 11, wherein the CFA type is determined by correlating the extracted frequency signature with reference frequency signatures corresponding to known CFA types.

13. The apparatus of claim 11, wherein to apply the frequency-domain transform to each CFA image to extract the frequency signature, the at least one processing unit is configured to:
convert the CFA image into frequency domain data;
extract horizontal and vertical mid-slices of the frequency domain data; and
average the horizontal and vertical mid-slices to obtain the frequency signature.

14. The apparatus of claim 10, wherein when the input CFA data comprise a single CFA image, to process the latent embedding using the central core to generate core latent embeddings further, the at least one processing unit is configured to:
process the latent embeddings using a core encoder to extract core features for generation of the core latent embeddings.

15. The apparatus of claim 10, wherein when the input CFA data comprise a plurality of CFA images, to process the latent embedding using the central core to generate the core latent embeddings, the at least one processing unit is configured to:
process the latent embedding corresponding to each CFA image among the plurality of CFA images to extract core features corresponding to each CFA image;
generate a saturation map and a motion map between the core features of the plurality of CFA images; and
blend the core features of the plurality of CFA images based on the saturation map and the motion map to generate the blended core latent embedding.

16. The apparatus of claim 15,
wherein the saturation map and the motion map provide weights to the core features of the plurality of CFA images, and
wherein the blending of the core features is performed based on the corresponding weights.

17. One or more non-transitory computer-readable storage media storing one or more computer programs including computer-executable instructions that, when executed by one or more processors of an electronic device individually or collectively, cause the electronic device to perform operations, the operations comprising:
receiving an input CFA data comprising one or more CFA images from one or more CFAs;
determining a CFA type associated with each CFA image of the one or more CFA images using a CFA identification module;
identifying, for each CFA image, a CFA-specific encoder from an encoder pool based on the determined CFA type;
encoding each CFA image using the identified CFA-specific encoder to generate a latent embedding corresponding to each CFA image;
processing the latent embedding of each CFA image using a central core to generate core latent embeddings; and
generating a linear red, green, blue (RGB) image by decoding the core latent embeddings using a decoder.

18. The one or more non-transitory computer-readable storage media of claim 17, wherein determining the CFA type comprises:
applying a frequency-domain transform to each CFA image to extract a frequency signature; and
using the extracted frequency signature to determine the CFA type.
